(19) United States
(12) Patent Application Publication
(10) Pub. No.: US 2018/0233027 A1
(43) Pub. Date: Aug. 16, 2018

(54) Systems and Methods for Suppressing Monitoring Based on Environmental Inputs

(71) Applicants: AT&T Intellectual Property I, L.P., Atlanta, GA (US); AT&T Mobility II LLC, Atlanta, GA (US)

(72) Inventors: William Francis Bradee, Plano, TX (US); Steven Martin, Plano, TX (US); David Gordon Marten, Sachse, TX (US)

(21) Appl. No.: 15/433,770

(22) Filed: Feb. 15, 2017

(51) Int. Cl. G08B 29/18; G06F 1/32; G08B 25/10

(52) U.S. Cl. CPC G08B 29/185; G08B 25/10; G06F 1/3206

(57) ABSTRACT

A system and method for adjusting the power mode in a monitoring device is based on the determination of the presence of a contra-indicator. If the contra indicator is present monitoring device is placed in a low power mode. If the contra indicator is not present the monitoring device is placed in a high power mode capable of transmitting a signal from the monitoring device. The activation of the monitoring device may be based on an environmental stimulus. The monitoring device may connect wirelessly to a wide area communication network if the contra-indicator is not present.

### TECHNICAL FIELD

The present disclosure relates generally to monitoring devices and systems. More specifically the present disclosure relates to methods and systems that prevent reporting from a monitoring device based on environmental inputs.

### BACKGROUND

Traditional monitoring devices such as asset tracking devices report periodically, or automatically upon some stimulus (e.g. movement). This consumes power even if the report is not of interest to a user. The unnecessary consumption of power impacts the energy requirements of the asset tracking device. This impact is usually addressed by providing longer-lived battery or attachments to recharging power supplies. For example, a microprocessor in sleep mode draws as low as 5 micro amps. A short range RF sensing circuit can draw 2 micro amps. A Bluetooth receiver can draw 10 milliamps. Transmitting a cellular signal requires 500 milliamps. Accordingly, unnecessary transmission of cellular signals imposes an unnecessary drain of the battery resources of the asset tracking device.

An illustrative application of an asset tracking device is the monitoring tool trailers. Tool trailers are portable assets that move periodically from job site to depot to job site. The asset tracking device may be used to determine whether the tool trailer is being moved by an unauthorized user. Thus periodically reporting where the tool trailers are located provides the user with valuable information to prevent theft. However, tool trailers may be left parked for extended periods and reporting on the location of the tool trailer in those circumstances is wasteful of energy resources. Among the solutions to this problem may be to add energy harvesting capabilities, large batteries, or external power supplies, but these solutions add cost and complexity.

Other application of asset tracking solutions is the monitoring of goods in transport. Goods are stored and initially shipped in aggregate (either a pallet, shipping container, or other means). Each unit or suitable sub-quantity (e.g. box) can be individually tracked. Another use is when the tracking device is reading sensors in shipped goods. For example, Bluetooth sensors in pallets of a perishable product. The product may have a long time between production and delivery.

A solution is needed that can be hidden in the asset being tracked and only activated when a report is of interest to the user.

### SUMMARY

One general aspect includes a method including activating a monitoring device, and determining if a contra-indicator is present. If the contra indicator is present placing the monitoring device in a low power mode. If the contra indicator is not present placing the monitoring device in a high power mode capable of transmitting a signal from the monitoring device. Other general aspects include a method where the step of activating the monitoring device includes activating the monitoring device based on an environmental stimulus. The method also includes the step of activating the monitoring device and may include activating the monitoring device on a periodic basis. The method may also include connecting wirelessly to a wide area communication network if the contra-indicator is not present. The method may also include accessing a programmable policy in the monitoring device if a contra-indicator is present. The method may also include determining when the signal is transmitted based on the programmable policy.

Another aspect includes a system having a monitoring device with a reporting component. The system also includes a sensor and a processor in the monitoring device. Memory in communication with the processor is also provided wherein the processor executes instructions stored in the memory to activate the monitoring device, and determining if a contra-indicator is present. If a country-indicator is present placing the monitoring device and a low power mode and if the contra-indicator is not present placing the monitoring device in a high power mode.

Other embodiments of this aspect include corresponding computer systems, apparatus, and computer programs recorded on one or more computer storage devices, each configured to perform the actions of the methods.

One general aspect includes computer readable medium having instructions stored thereon that, when executed by a processor cause a monitoring device to activate the monitoring device, and determine if a contra-indicator is present. If a contra-indicator is present placing the monitoring device in a low power mode, and if the contra-indicator is not present placing the monitoring device in a high power mode capable of transmitting a signal from the monitoring device. Another aspect includes computer readable medium where the instructions to activate the monitoring device includes instructions to activate the monitoring device on a periodic basis. The machine readable medium may also include instructions to connect wirelessly to a wide area communication network if the contra-indicator is not present. The machine readable medium may also include instructions to access a programmable policy in the monitoring device if a contra-indicator is present.

### BRIEF DESCRIPTION OF THE DRAWINGS

FIG. 1 is a schematic diagram of an embodiment of a system for suppressing monitoring in accordance with an embodiment of the present disclosure.

FIG. 2 is a flowchart of a process for suppressing monitoring in accordance with an embodiment of the present disclosure.

### DETAILED DESCRIPTION OF ILLUSTRATIVE EMBODIMENTS

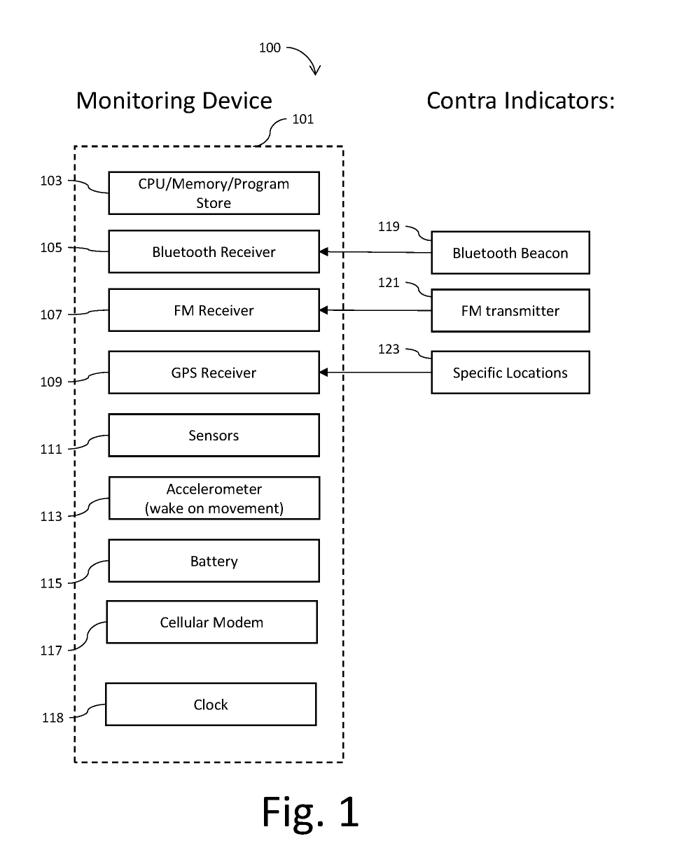

Illustrated in FIG. 1 is a block diagram of a monitoring system 100. Monitoring system 100 includes a monitoring device 101 which may include a plurality of components. For example, monitoring device 101 may include a CPU/memory/program store 103 for processing instructions to the monitoring device 101 such as authorization signals and performing in situ analysis of environmental data to determine if an event is a reportable event. The CPU/memory/program store 103 adds intelligence to the monitoring device 101 to limit reporting only when no contra-indicator is present. Monitoring device 101 may include a Bluetooth receiver 105, and FM receiver 107, and a GPS receiver 109. Monitoring device 101 may additionally include sensors 111 capable of detecting changes in the environment such as for example with perishable products the user may want to monitor temperature, humidity, etc. In another embodiment, monitoring device 101 may have an accelerometer 113 that causes a monitoring device 101 to activate upon movement of the monitoring device 101. The monitoring device 101 may also include a battery 115. In an embodiment monitoring device may include a reporting component such as cellular modem 117 capable of connecting wirelessly to a wide area and communication network (e.g. a cellular network) to provide alert information.

Monitoring system 100 may also include one or more contra-indicator components, such as a Bluetooth beacon 119, or an FM transmitter 121 or other radio signal. In one embodiment the contra-indicator may be specific locations programmed into the monitoring device 101. The contra-indicator may be the presence of a signal, or the absence of a signal. A device capable of providing a contra-indicator may be a key fob which includes a circuit board with a radio transmitter and control chip. When the user hits the button the fob broadcasts a code and a command. If the transmission matches the code in the receiver's memory, the command is carried out.

In this discussion the term contra-indicator may refer to a mobile contra-indicator such as a security encoded RF fob, or an RF signal, or even specific locations. The majority of power is consumed by communicating over the wide area network. Tracking devices have power budgets related to number of network transmissions. By eliminating reporting when contra-indicators are present, the battery life is vastly extended. This reduces cost by allowing for smaller battery size. For example there are several levels of power consumption in such a device: Sleep mode requires a few micro amps. In sleep mode the processor is waiting for environmental stimulus. Active mode requires another order of magnitude of energy consumption. In the active mode the CPU/memory/program store 103 is simultaneously looking for authorization signal and performing in situ analysis of environmental data to determine if this is a reportable event. If it is not a reportable event, or there is a contra-indicator, the system remains in low power mode. If the event warrants communication over a wide area network, the higher power communication network can be enabled. This draws watts of power versus micro amps. It uses the bulk of the power budget. By limiting high power usage only to times when no contra-indicator is in the area, the battery life of the monitoring device 101 can be extended for years. Another advantage of extending the battery life is that the battery does not need to be easily serviceable (replace). This means that the battery can be more tightly embedded in the asset making it harder to detect and defeat.

One example of a mobile contra-indicator is a portable hardware device (e.g. a key fob, smartphone, pda or the like) that is capable of broadcasting an encoded message either on-demand or continuously. The range of this communication is very short to ensure the source is within range of the tracking device. If the tracker is awoken by stimulus, or by schedule, it will check to see if a contra-indicator is present. If not, it will connect wirelessly to a wide-area communication network (e.g. cellular) to provide alert information. A programmable policy can be pre-loaded or updated to the device to determine behavior once a contra-indicator is detected—for example send periodic updates until re-armed, send only one update, send update only upon moving a certain distance, send frequent updates until power is exhausted, etc.

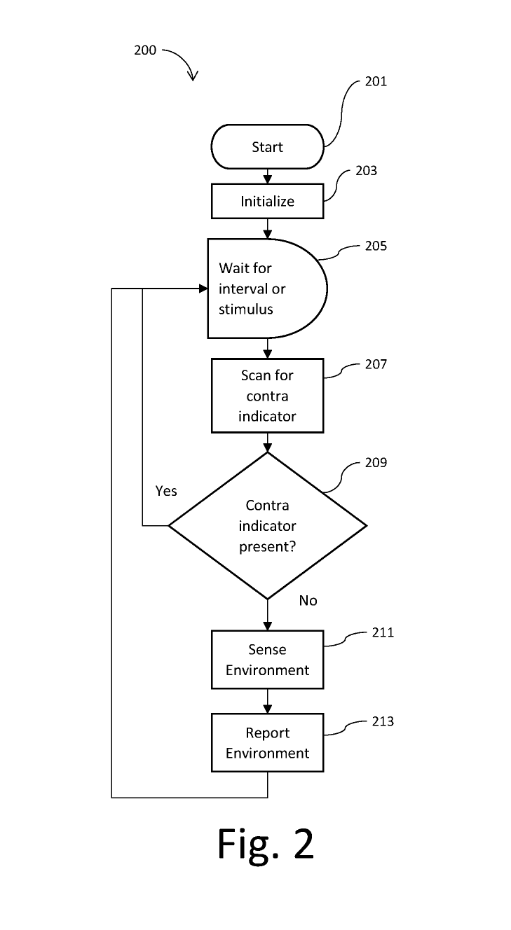

Illustrated in FIG. 2 is a flow chart of a method 200 for suppression of monitoring based on environmental inputs.

The method 200 starts with step 201.

In step 203 the method 200 initializes the monitoring device 101.

In step 205 the method waits for an interval or stimulus to trigger reporting by the monitoring device 101. Thus the monitoring device is activated based on an environmental stimulus or on a periodic basis.

In step 207 the method 200 scans for a contra-indicator.

In step 209 the method 200 determines whether contra-indicator is present. In one embodiment, if the contra-indicator is present then the method 200 loops back to step 205 to wait for an interval or stimulus thereby placing the monitoring device 101 in a low power mode. In another embodiment the method 200 may access a programmable policy in the monitoring device to determine the next course of action.

If no contra-indicator is present, then the method 200 senses the environment in step 211.

In step 213 the method 200 places the monitoring device in a high power mode capable of transmitting a signal from the monitoring device and reports on the environment. This may be accomplished by connecting to a wide-area communication network.

### EXAMPLES

In one embodiment, the monitoring system 100 may be implemented in an asset tracking solution. Traditional asset tracking solutions report periodically, or automatically upon some stimulus (e.g. movement). This consumes power even if it is not interesting. A monitoring device 101 may be incorporated in the tool trailer that will limit reporting only when no contra-indicator is present. For example, the contra-indicator may be a location. In that embodiment, the monitoring device 101 will not report the location of the tool trailer if the location of the tool trailer is the depot where the tool trailer is stored. When the tool trailer is being moved by an authorized user, the authorized user may provide a contra-indicator signal so that the monitoring device 101 will not report the location of the tool trailer as it's been moved by the authorized user. Upon arrival at the job site the user may disable the contra-indicator so that the monitoring device 101 can report the location of the tool trailer.

In another embodiment the monitoring system may be implemented in a solution involving the shipment of goods. For example the monitoring device 101 may include Bluetooth sensors, and the monitoring device may be attached to pallets of the perishable product. The product may have a long time between production and delivery, but at points along the way (and trucks, at warehouses) there may be other devices (gateways) with ample power to read information from sensors and report to a monitoring system. These gateways can broadcast a contra-indicator to prevent the battery-operated devices from wasting their power to report sensors in the area.

An aspect of the invention is implemented as a program product for use with a computer system. Program(s) of the program product defines functions of embodiments and can be contained on a variety of machine-readable media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to embodiments of the present invention, other and further embodiments of the invention may be devised without departing from the basic scope thereof, and the scope thereof is determined by the claims that follow.

1. A method comprising:
activating a monitoring device based on a stimulus;
determining if a mobile contra-indicator capable of broadcasting a security encoded radio frequency signal is within a communication range;
if the mobile contra-indicator is within the communication range accessing a programmable policy on the monitoring device; and
implementing an action by the monitoring device based on the programmable policy.

2. The method of claim 1 wherein the mobile contra-indicator is a security encoded fob.

3. (canceled)

4. The method of claim 1 wherein the step of activating the monitoring device comprises activating the monitoring device on a periodic basis.

5. The method of claim 1 further comprising connecting wirelessly to a wide area communication network if the mobile contra-indicator is not within the communication range.

6. (canceled)

7. The method of claim 1 wherein the programmable policy determines when a signal is transmitted from the monitoring device.

8. A system comprising:
a monitoring device having a reporting component;
a mobile contra-indicator capable of broadcasting a security encoded radio frequency signal having a communication range;
a sensor in the monitoring device wherein the sensor is capable of sensing the mobile contra-indicator if the mobile contra-indicator is within the communication range;
a processor in the monitoring device
a memory in communication with the processor wherein the processor executes instructions stored in the memory to:
activate the monitoring device;
determine if the mobile contra-indicator is within the communication range;
if the mobile contra-indicator is within the communication range accessing a programmable policy on the monitoring device; and
implementing an action by the monitoring device based on the programmable policy.

9. The system of claim 8 wherein the mobile contra-indicator is a security encoded fob, an RF signal or a specific location.

10. The system of claim 8 wherein the instructions stored in the memory to activate the monitoring device comprises instructions stored in the memory to activate the monitoring device based on an environmental stimulus.

11. The system of claim 8 wherein the instructions to activate the monitoring device comprises instructions to activate the monitoring device on a periodic basis.

12. The system of claim 8 further comprising instructions to connect wirelessly to a wide area communication network if the mobile contra-indicator is not within the communication range.

13. (canceled)

14. (canceled)

15. A machine readable medium having instructions stored thereon that, when executed by a processor, cause a monitoring device to:
activate the monitoring device;
determine if a mobile contra-indicator capable of broadcasting a security encoded radio frequency signal is within a communication range;
if the mobile contra-indicator is within the communication range access a programmable policy on the monitoring device; and
implement an action by the monitoring device based on the programmable policy.

16. The machine readable medium of claim 15 wherein the mobile contra-indicator is a security encoded fob, an RF signal or a specific location.

17. The machine readable medium of claim 15 wherein the instruction that cause the monitoring device to activate the monitoring device comprises instructions that cause the monitoring device to activate the monitoring device based on an environmental stimulus.

18. The machine readable medium of claim 15 wherein the instructions that cause the monitoring device to activate the monitoring device comprises instructions that cause the monitoring device to activate the monitoring device on a periodic basis.

19. The machine readable medium of claim 15 further comprising instructions that cause the monitoring device to connect wirelessly to a wide area communication network if the mobile contra-indicator is not within the communication range.

20. (canceled)
